(19) United States
(12) Patent Application Publication
(10) Pub. No.: US 2010/0202246 A1
(43) Pub. Date: Aug. 12, 2010

(54) MULTICOMPONENT PACKAGING

(76) Inventors: Wolf-Ruediger Huck, Zurich (CH); Dana Maiwald, Zurich (CH); Jolanda Sutter, Oberwil (CH); Olivier Keller, Hegnau (CH)

Correspondence Address: BUCHANAN, INGERSOLL & ROONEY PC, POST OFFICE BOX 1404, ALEXANDRIA, VA, 22313-1404, US

(21) Appl. No.: 12/597,795

(22) PCT Filed: Apr. 28, 2008
(86) PCT No.: PCT/EP2008/055163

§ 371 Date: Mar. 31, 2010

(30) Foreign Application Priority Data
Apr. 27, 2007 (EP) 07107159.1

(51) Int. Cl. B65D 81/32; B01F 15/02

(52) U.S. Cl. 366/185; 220/523

(57) ABSTRACT

A multicomponent packaging is disclosed for an adhesive with at least one first and at least one second component. A first chamber is provided for accommodating the first component of the adhesive, the first chamber having an opening for removal of the adhesive. A second chamber is arranged within the first chamber for accommodating the second component of the adhesive. A sealing means is provided which, in the stored state of the multicomponent packaging, seals the opening in a fluid-tight manner.

### TECHNICAL BACKGROUND

The present invention relates to a multicomponent packaging,

in particular for adhesion promoters.

### TECHNICAL FIELD/PRIOR ART

Although they can be applied to any desired multicomponent packaging, the present invention and the problem on which it is based will be explained in more detail below with reference to a two-component packaging for adhesion promoters.

Adhesion promoter substances have been used for a long time to improve adhesion, in particular that of adhesives and sealing materials. In particular, silane and titanate compounds have been known for a long time as such adhesion promoter substances. It has been shown that, in specific cases, depending on the material and nature of the surfaces and the adhesive or sealing material used, quite specific adhesion promoter substances or mixtures thereof have to be selected. This adhesion promoter composition is used as a primer or adhesion activator for the pretreatment of surfaces to be adhesively bonded or sealed off. On the one hand, in the prior art, such adhesion promoter substances are dissolved in an inert, easily volatile solvent and, as a result, if moisture is excluded, can be stored over a relatively long time. During the application of this adhesion promoter composition to a surface, the easily volatile solvent evaporates and the atmospheric humidity hydrolyzes the adhesion promoter substances and leads to their condensation with one another and possibly with polar groups belonging to the surface. However, this reaction needs a certain time until the adhesion has built up.

If these adhesion promoter substances come into contact with water, they hydrolyze and condense to form oligomers and/or polymers. During the application of such oligomers and, above all, such polymers, however, a noticeably poorer adhesion promoter action, as far as none at all, very frequently occurs. It has been shown that the buildup of adhesion is often insufficient if a very rapidly cross-linking adhesive, in particular a very rapid polyurethane adhesive, is applied to the adhesion promoter composition.

Two-component systems are described, for example, in the document WO2005/093002. In these systems, a precursor compound and an activation agent are kept for storage in two chambers, which are sealed within a pack, separated from each other but adjoining one another. Two-component systems are advantageous in particular since it is possible to set an exact mixing ratio between the precursor compound and the activation agent. During the application to the surface to be treated, in the ideal case the precursor compound is mixed with the activation agent and thus leads to the activation of the precursor compound within an extremely short time.

In the ideal case, therefore, since in the case of the two-component systems described an application of the precursor compound to a surface to be treated without any previous mixing with the activation agent or, conversely, an activation of the activation agent to a surface to be treated without any previous mixing with the precursor compound is not ruled out. This therefore results in the risk that, during the adhesive bonding of components with the treated surface, only inadequate adhesion promotion is provided. However, in particular in the area of safety-relevant components, for example windshields of vehicles, this is not tolerable.

### SUMMARY OF THE INVENTION

It is therefore an object of the present invention to provide an improved multicomponent packaging and an improved method for the removal from the latter.

According to the invention, this object is achieved by a multicomponent packaging having the features of patent claim 1 and/or a method for the removal of a mixture from a multicomponent packaging according to patent claim 14.

Accordingly, a multicomponent packaging is provided for packaging at least a first and a second component, having a first chamber to hold the first component, the first chamber having an opening for the removal of a mixture of the at least first and second component, having a second chamber arranged within the first chamber to hold the second component, and having a closure means which, in a stored state of the multicomponent packaging, closes the opening in a fluid-tight manner.

Furthermore, a method is provided for the removal of a mixture from a multicomponent packaging having at least one first chamber, which holds a first component, and a second chamber arranged within the first chamber, which holds a second component, having the following steps: piercing the second chamber by means of a piercing means, mixing the first and second component to form the mixture, opening an opening in the first chamber closed by means of a closure means, and pouring the mixture out of the opening.

The idea on which the present invention is based is that the closure means opens the opening in the first chamber only when or at least during deliberate mixing of the two components has taken place or is taking place. Accordingly, the components can be applied to a surface to be treated only in the mixed state. Thus, adequate adhesion promotion is ensured between the surface to be treated and, for example, adhesive or sealing materials, varnish and so on applied to the latter.

Advantageous refinements, improvements and developments of the multicomponent packaging specified in patent claim 1 and of the method for removal of an adhesion promoter specified in patent claim 16 will be found in the subclaims.

In the present case, “chamber” is to be understood to mean a volume which is virtually completely or completely enclosed by a wall.

In the present case, “piercing” a chamber is to be understood to mean the production of one or more openings in a region or in a plurality of regions, in particular including opposite regions, of the chamber.

In the present case, “opening” the opening is also to be understood to mean only partial opening.

According to a preferred refinement of the invention, a piercing means for piercing the second chamber by means of shaking the multicomponent packaging is furthermore arranged within the first or second chamber. In the present case, “shaking” is to be understood to mean an acceleration, in particular a periodic acceleration, in opposite directions. In the present case, a “piercing means” is to be understood to mean any type of means which permits the second chamber to be pierced and, in the process, comes directly into contact with the latter. An arrangement of the piercing means in the first or second chamber is advantageous in as much as it can in this way be integrated into the multicomponent packaging in a straightforward manner without, for example, a separate part having to be carried along as well.

The closure means is preferably arranged substantially within the first chamber.

According to a further preferred embodiment of the invention, the closure means is formed by the second chamber itself. As a result, the piercing means advantageously only has to pierce the second chamber before the opening in the first chamber is opened. In the process, the piercing means, coming from an interior of the first chamber, preferably pierces a first wall of the second chamber which faces the interior of the first chamber, so that an aperture is made in said first wall, through which the second component can flow into the interior of the first chamber and there mix with the first component. If shaking is then continued, the piercing means also pierces a wall that is now accessible through the aperture produced and faces away from the interior of the second chamber. This therefore produces an opening in the multicomponent packaging through which the adhesion promoter formed by mixing the first and second component can be poured out.

In a further preferred embodiment of the invention, the piercing means is permanently coupled to the closure means and, in relation to the second chamber, is arranged in such a way that a piercing movement of the piercing means effects the piercing of the second chamber and actuates the closure means to open the opening. Thus, simultaneous opening of the opening and piercing of the second chamber, and therefore mixing of the second component with the first component, are advantageously achieved.

However, it is also conceivable for the piercing means to be coupled mechanically to the closure means in such a way that the piercing movement of the piercing means firstly effects piercing of a wall of the second chamber that faces the piercing means and only when the piercing movement the piercing means is continued is the closure means actuated in order to open the opening. This guarantees that the first and second component are given a certain amount of time in order to mix until the closure means opens the opening. “Mechanically coupled” means, for example, a shoulder on the piercing means which comes into engagement with the closure means only when the piercing movement is continued and then actuates said closure means in order to open the opening.

In a further preferred improvement of the invention, the closure means is formed by the piercing means itself. In this case, the piercing means performs a dual function: firstly, it serves to pierce the second chamber, secondly as a closure means. This is advantageous with regard to the effort of production of the multicomponent packaging.

In a further preferred refinement of the invention, a retaining means is provided, which is preferably arranged in the area of the opening and which retains the piercing means in the stored state and releases the piercing means as a function of an acceleration acting on the multicomponent packaging. The acceleration acting can in this case result from a shaking operation of the multicomponent packaging. Inadvertent release of the piercing means and therefore possible inadvertent destruction of the second chamber can be prevented by means of the retaining means. Suitable retaining means are, for example, adhesives, thin sheets and/or threads. However, rubber, webs and other retaining devices on the closure would also be conceivable.

According to a further preferred embodiment of the invention, the second chamber has a wall which is designed in such a way that a piercing movement of the piercing means with a predetermined kinetic energy leads to the piercing of the second chamber. In this case, the design of the wall is carried out by means of the wall thickness and/or the material and/or the geometry of the wall. During the shaking, the kinetic energy both of the piercing means and of the preferably liquid first and second component rises. The kinetic energy of the piercing means in this case has a predetermined relationship with the kinetic energy of the first and second component. Good thorough mixing of the first and second component is ensured in particular when the first and second component meet each other with a predetermined kinetic energy. This is ensured by the fact that the wall of the second chamber can be pierced only when the piercing means itself reaches a predetermined kinetic energy.

In a further preferred embodiment of the invention, the first chamber is designed to be flexible and the second chamber is joined to the closure means in such a way that end compression of the first chamber leads to piercing of the closure means, the end compression of the first chamber previously necessitating piercing or fracture of the second chamber. Preferably, part of the second chamber itself forms the closure means, it additionally being possible, in particular for a sealing function, for suitable sealing means to be provided between the second chamber and the first chamber in the region of the opening. The first chamber is preferably formed as a collapsible bottle, which makes end compression of the latter easier. In this case, the pressure applied to the second chamber during the end compression of the first chamber leads to complete breakage of the second chamber, so that the opening is opened and, preferably at the same time, the first and the second component mix with each other. It is also possible to provide the second chamber with an intended fracture point, which fractures during a first end compression of the first chamber and thus releases the second component to mix with the first component, a second end compression following the first end compression then leading to piercing of the closure means. This development also ensures that mixing of the first and second component take place before the opening is opened in order to pour the adhesion promoter out from the first chamber.

According to a further preferred embodiment of the invention, a wall of the second chamber is formed of glass and/or metal (preferably aluminum) and/or plastic. The material of the wall, together with the material and the shape of the piercing means, determines to a considerable extent the conditions under which the piercing means pierces the wall of the second chamber.

According to a further preferred embodiment of the invention, the first chamber has an in particular pipe-shaped spout adjoining a base body and, if need be, a pourer adjoining the latter. This makes it easier to apply or decant the adhesion promoter onto a surface to be treated. According to the present invention, the spout and, if present, the pourer, is a part of the first chamber. The “opening” in the first chamber is preferably formed by the spout, in particular by the transition between the base body and the spout, and/or by an opening in the pourer that adjoins the spout.

The pourer is in particular a pipe-shaped and/or closable. The pipe-shaped pourer tapers to a smaller diameter than that of the spout. The configuration of the spout/pourer results in the possibility of applying the adhesion promoter in a more specific manner or of fitting on an application aid (sponge, felt). The spout/pourer can preferably be closed by means of a closure means, for example a closure cap, in such a way that although an adhesion promoter that is formed can flow out of an opening when the latter is open, when the closure means is closed, any flow out of the multicomponent packaging is prevented by means of the closure means.

According to a further preferred embodiment, the first component has an activation agent, for example water, and/or the second component has a precursor compound, for example a silane and/or titanate compound that can be hydrolyzed. A mixture of the latter leads to an activated adhesion promoter.

According to a further preferred embodiment of the invention, the piercing means, in particular at least one ball, has a harder or at least more solid material than that of a wall of the second chamber and/or cutting means for boring through the wall of the second chamber, or it has a different composition, which leads to fracture or boring through. This ensures that the piercing means is capable of piercing the wall of the second chamber. The cutting means can be formed, for example, as a spike on the at least one ball.

According to a further preferred embodiment of the invention, the first chamber is partly filled. It is thus made possible for the first component to achieve a sufficient kinetic energy before the piercing means pierces the second chamber. This therefore ensures good thorough mixing of the first and second component.

According to a further preferred embodiment of the method according to the invention, the second chamber is pierced first, the first and second component are then partly mixed, preferably homogeneously, to form the adhesion promoter and, furthermore, the opening in the first chamber is then opened. Pouring out the adhesion promoter without activating the same is thus ruled out.

According to a further preferred embodiment of the method according to the invention, as the second chamber is pierced, firstly a wall of the second chamber facing a the first chamber and then a wall facing away from the first chamber, which forms the closure means and belongs to the second chamber, is pierced by the piercing means. Thus, mixing of the first and second component is ensured before the wall facing away is pierced. Piercing the wall of the second chamber that faces away has the effect of opening the opening of the first chamber in order to pour out the then activated adhesion promoter.

In a further preferred improvement of the method according to the invention, during the piercing or directly following the piercing of the second chamber, the closure means is moved in order to open the opening, by means of a mechanical coupling to the piercing means. Here, too, the advantage resides in the fact that the opening of the second chamber is opened only when the second chamber is or has been pierced, so that mixing of the first and second component occurs.

In a further preferred embodiment of the method according to the invention, the second chamber is firstly pierced by means of end compression of the first chamber and the opening in the first chamber is then opened by still further end compression. In this case, the end compression leads to a mixing movement, and mixing of the first and second component is also ensured here before the opening in the first chamber is opened to pour out the activated adhesion promoter.

According to a further preferred embodiment of the method according to the invention, the opening in the first chamber is opened by the piercing means, which forms the closure means, and at the same time the second chamber is pierced by the piercing means and the first and second component are mixed to form the adhesion promoter.

### BRIEF DESCRIPTION OF THE DRAWINGS

The invention will be explained in more detail below by using exemplary embodiments illustrated schematically in the figures, in which:

FIG. 1 shows a cross-sectional view of a multicomponent packaging according to an exemplary embodiment of the present invention;

FIG. 2 shows a cross-sectional view of a multicomponent packaging according to a further exemplary embodiment of the present invention;

FIG. 3 shows a cross-sectional view of a multicomponent packaging according to a still further exemplary embodiment of the present invention;

FIG. 4 shows a cross-sectional view of a multicomponent packaging according to a still further exemplary embodiment of the invention;

FIG. 4A shows a variation of the detail A according to FIG. 4 in a partial view;

FIG. 4B shows a variation of the detail A according to FIG. 4 in a partial view;

FIG. 5 shows a cross-sectional view of a multicomponent packaging according to a still further exemplary embodiment of the present invention;

FIG. 6 shows a cross-sectional view of a multicomponent packaging according to a still further exemplary embodiment of the present invention;

FIG. 7 shows a variation of the exemplary embodiment according to FIG. 6 in a partial view; and

FIG. 8 shows a further variation of the exemplary embodiment according to FIG. 6 in a partial view;

FIG. 9 shows a cross-sectional view of a multicomponent packaging according to a still further exemplary embodiment of the present invention;

FIG. 10 shows a cross-sectional view of a multicomponent packaging according to a still further exemplary embodiment of the present invention;

FIG. 11 shows a cross-sectional view of a multicomponent packaging according to a still further exemplary embodiment of the present invention.

In the figures, the same designations designate the same or functionally identical components.

### DESCRIPTION OF THE PREFERRED EMBODIMENTS

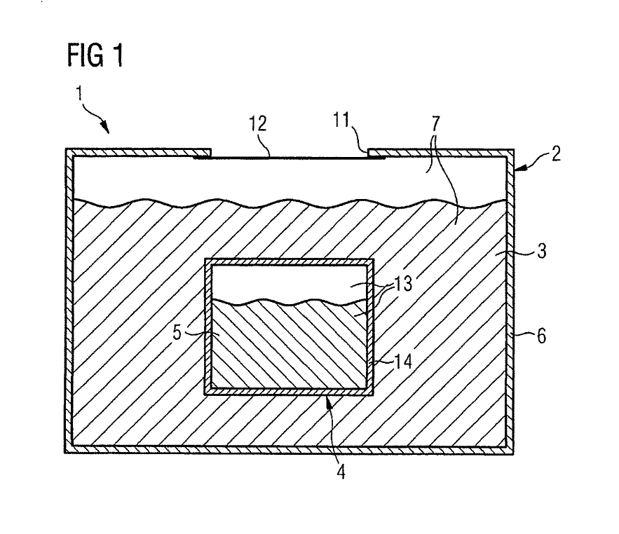

FIG. 1 shows a cross-sectional schematic view of a multicomponent packaging 1 according to one exemplary embodiment of the present invention, the intention being to illustrate the basic structure according to the invention.

The multicomponent packaging 1 has a first chamber 2 to hold a first component 3 and a second chamber 4 arranged within the first chamber 2 to hold a second component 5.

The first component 3 is preferably formed as an activation agent, in particular water, and, if need be, further additives such as acids, wetting agents, dyestuffs and so on. The second component 5 is preferably formed as a precursor compound, in particular a silane or titanate compound and, if need be, additives such as dyestuffs and so on.

The first chamber 2 has a wall 6 which surrounds a space 7. The first chamber 2 preferably has a form suitable for handling, for example the form of a bottle.

The wall 6 of the first chamber 2 is provided with an opening 11 which, in a stored state of the multicomponent packaging 1, is closed by means of a closure means 12 preferably arranged within the first chamber 2, for example a thin sheet or a lid.

This thus prevents the first component 3 escaping from the opening 11 in the stored state of the multicomponent packaging 1.

The second chamber 4 has a space 13 in which, in the stored state, the second component 5 is arranged and which is preferably enclosed completely by a wall 14 of the second chamber 4. The form of the second chamber 4 is virtually arbitrary.

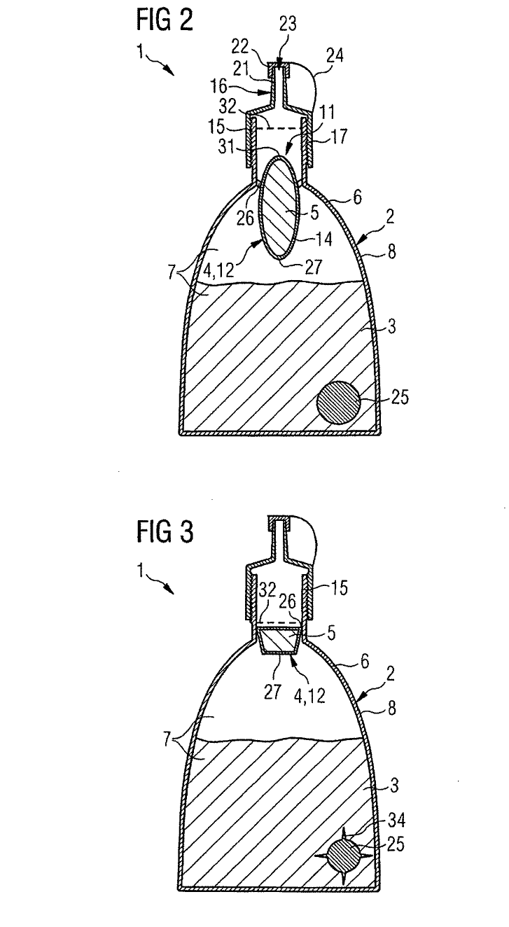

With respect to the exemplary embodiments according to FIGS. 2 to 8, only the differences from the basic exemplary embodiment from FIG. 1 will be explained below.

According to the exemplary embodiment of FIG. 2, the first chamber 2 is constructed approximately in the form of a bottle, the first chamber 2 having a spout 15 adjoining a base body 8 and forming the opening 11. The spout 15 is preferably joined to a pourer 16, preferably by means of a screw connection 17, or (not illustrated), by using a plug-in connection or pressed connection. The pourer 16 is preferably itself constructed in the shape of a pipe and, at its end 21 facing away from the first chamber 2, is provided with a closure 22 for closing an opening 23 in the pourer 16. The closure 22 is connected to the pourer 16 via a flexible securing strip 24 to retain the closure 22 when the latter is removed.

According to the exemplary embodiment of FIG. 2, a piercing means 25 is arranged in the first chamber 2 such that it can move freely and is preferably formed as a ball, for example made of steel.

According to the exemplary embodiment of FIG. 2, the closure means 12 is formed as the second chamber 4. In this case, the wall 14 of the second chamber 4 seals off with the wall 6 of the first chamber 2 in a sealing region 26 in a fluid-tight manner. Here, a retaining or sealing means, in particular an adhesive and/or a resilient seal, can additionally be introduced into the sealing region 26, firstly improving the liquid tightness and secondly keeping the second chamber 4 in a state closing the spout 15.

The wall 14 of the second chamber 4 is preferably produced from glass and preferably has an oval cross section. The oval cross section of the second chamber 4 promotes increased stability of the wall 14, which means that a wall thickness of the wall 14 may advantageously be reduced. This advantageously leads to a saving in material.

If, then, by means of the multicomponent packaging 1, an adhesion promoter is to be provided in a ready-to-use state, then the multicomponent packaging 1 is shaken, for example by an operator or by means of a shaking machine (not illustrated). In this case, the first chamber 2 can preferably be only partly filled with the first component 3. As a result of the shaking movement of the multicomponent packaging 1, the piercing means 25 begins to move. If the piercing means 25 strikes the wall 14 of the second chamber 4 with sufficient kinetic energy, then the piercing means 25 preferably firstly pierces the end 27 of the second chamber 4 that faces away from the sealing region 26 and points into the space 7. During the piercing action, in the case of a wall 14 formed from glass, abrupt brittle fracture of said wall occurs in the region of the end 27. The first component 3 then mixes with the second component 5, then liberated. In this case, the thickness of the wall 14 and its material and the material and the form and the weight of the piercing means 25 are coordinated with one another in such a way that the end 27 is pierced only when, firstly, there is no unintended movement, for example as a result of the transport of the multicomponent packaging 1, and, secondly, the first and/or the second component are moving in such a way that very homogeneous mixing of these is carried out rapidly as the end 27 is pierced.

The above-described coordination of the wall 14 and the piercing means 25 is preferably carried out in such a way that the piercing means 25, after piercing the end 27, has lost so much kinetic energy that immediate piercing of the end 31, which faces away from the sealing region 26 and the space 7, of the wall 14 of the second chamber 4, i.e. following the piercing of the end 27, is prevented.

As a result of further shaking, the piercing means picks up kinetic energy again, during which it preferably ensures good thorough mixing of the first component 3 and the second component 5.

Once the piercing means 25 reaches a further predetermined level of kinetic energy, it pierces the end 31 of the wall 14, it then being made possible to pour the mixed first and second component 3, 5 forming an adhesion promoter out of the second chamber.

In exactly the same way, the material of the wall 14 of the second chamber 4 can be formed in such a way that it breaks down completely when pierced, preferably into many small pieces, in particular splinters, by which means mixing of the first and second component 3 and 5 and opening of the spout 15 is then achieved at the same time.

The adhesion promoter then preferably flows through a filter mesh 32, which filters any splinters, for example glass splinters, out of the destroyed wall 14. The filter mesh can also be a sponge, a frit and so on.

With the closure 22 removed, by means of the pipe-shaped pourer 16, the adhesion promoter can then be applied simply to a surface to be treated (not illustrated) or poured into another container, or a suitable application means can be plugged on.

The exemplary embodiment according to FIG. 3 differs from the exemplary embodiment according to FIG. 2 in that, in the exemplary embodiment according to FIG. 3, the second chamber 4 is formed with a substantially trapezoidal cross section. However, cross sections of other shapes are also conceivable.

By means of the trapezoidal form, the second chamber 4 forms a substantially planar surface 27 pointing toward the space 7.

According to the exemplary embodiment of FIG. 3, the wall 14 of the second chamber 4 is formed from a metal (preferably aluminum or an aluminum alloy) or a plastic or a composite material or combinations thereof.

Furthermore, in the present exemplary embodiment, the piercing means 25 is with spikes (provided with the designation 34 by way of example). However, any other desired cutting means such as cutting edges, cutting corners and so on can also be molded on.

Because the area 27 is oriented substantially perpendicular to an envisaged direction of movement of the piercing means, said area can simply be pierced by the spikes 34. In the exemplary embodiment according to FIG. 3, the end 27 is formed as an area which is oriented substantially perpendicular to an envisaged movement of the piercing means 25.

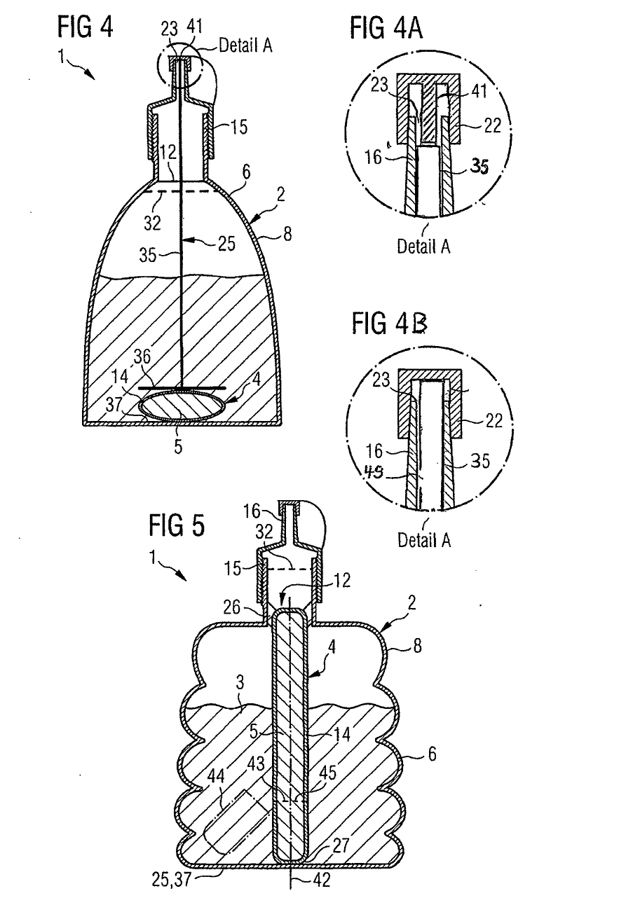

As distinct from the exemplary embodiment according to FIG. 2, in the exemplary embodiment according to FIG. 4 and FIG. 4A the piercing means 25 is formed as a rod 35 which, at its one end 36, rests against the wall 14 of the chamber 4, which is preferably arranged on a base 37 of the first chamber 2. The end 36 is preferably configured to be disk-shaped and can preferably also be configured as a mesh, the diameter of the end 36 then preferably corresponding to the internal diameter of the first chamber in this region. In this case, the rod 35 serves as a closure means, in addition the rod 35 can be firmly connected to a closure means 12 which is additionally provided, is formed as a closing plate and firmly closes the opening in the stored state illustrated.

If a predetermined force in the direction of the second chamber 4 is now applied to the closure 22 and a rod 41 integrated in the closure, the rod 35 is forced into the interior of the chamber 2 and the opening 23 is opened. As a result of the force applied to the closure, the wall 14, which is preferably formed of glass in the case of this exemplary embodiment, breaks and the first and second component 3 and 5 mix. If an additional closing plate is provided, the movement of the rod 35 in the direction of the second chamber 4 may cause the closing plate, which is firmly connected to the rod 35, to be moved together with the rod 35, and thus the spout 15 to be opened in order to provide the adhesion promoter.

FIG. 4B shows a further variant, in which the rod 35 is configured to be hollow and tubular and protrudes from the opening 23. Below the opening 23, the rod 35 has an opening 49. In the unused state, the rod 35 closes the opening 23. If the closure 22 is pressed down, the rod 35 is forced into the first chamber 2 and the second chamber 4 is destroyed in a manner analogous to that described above. The adhesion promoter can then be poured out via the opening 49 in the rod and the hollow rod.

The exemplary embodiment according to FIG. 5 differs from the exemplary embodiment according to FIG. 2 in that the second chamber 4 extends from the sealing region 26 as far as the base 37 of the first chamber 2, which is located opposite the spout 15, that is to say extends substantially perpendicular to the substantially annular sealing region 26.

In this case, the wall 6 of the first chamber 2 is flexible in the direction 42, in particular formed such that it can be end-compressed.

If a predetermined force is then applied to the piercing means 25 formed as a base 37, the wall 14 of the second chamber 4 initially breaks at an intended fracture point 43, whereupon the first and second components 3 and 5 mix with each other in order to form the adhesion promoter. The end 27 of the second chamber 4 preferably breaks off in the process, as illustrated (see designation 44). If a further predetermined force is then applied to the piercing means 25 from below, the latter comes into contact with the end 45 of the second chamber 4 that is assigned to the intended fracture point 43. In the meantime, the multicomponent packaging 1 can be shaken sufficiently in order to achieve the best possible mixing of the first and second component 3 and 5.

If a predetermined force is then applied to the end 45, the retaining means 28 tear off, by which means the spout 15 is opened to provide the adhesion promoter and the latter can be shaken out of the pourer 16.

In exactly the same way, the material of the wall 14 of the second chamber 4 can be formed in such a way that, when it is pierced by means of the piercing means 25 (base 37), it breaks down completely, preferably into many small pieces, in particular splinters, by which means mixing of the first and second component 3 and 5 and opening of the spout 15 and pourer 16 are then achieved at the same time.

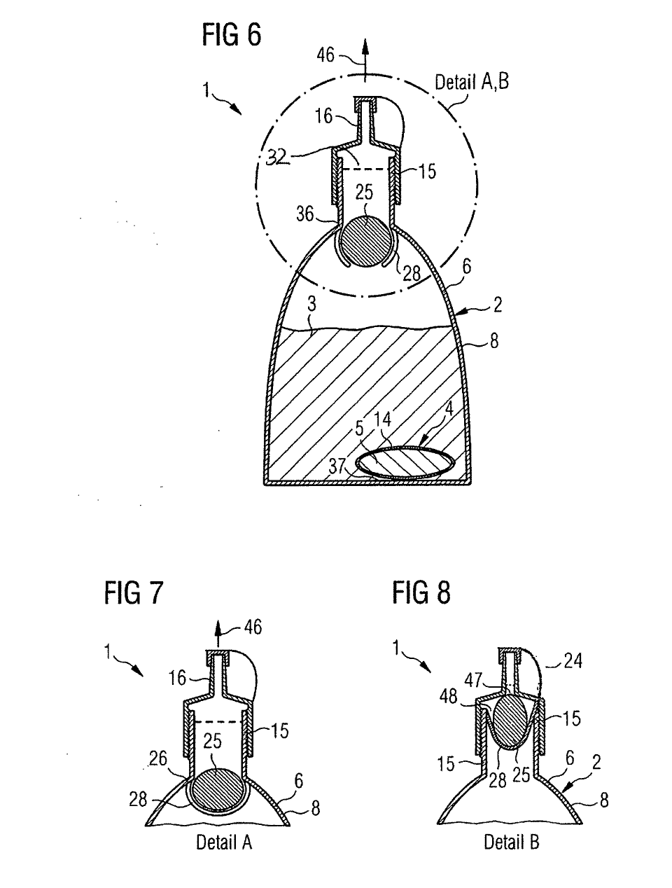

In the exemplary embodiment according to FIG. 6, the piercing means 25, together with retaining means 28, closes the spout 15 and pourer 16.

The second chamber 4 is preferably arranged in a region of the base 37 located opposite the piercing means 25. It can be retained there via suitable retaining means (not illustrated).

If the multicomponent packaging experiences a predetermined acceleration, in particular in a direction provided with the designation 46, then the retaining means 28 break off or are deformed elastically and thus release the piercing means 25 for a movement of the same in a direction opposite to the direction 46 relative to the first chamber 2. In the process, the spout 15 is opened. The piercing means 25 then strikes the wall 14, in particular of glass, and breaks through the latter, so that the first and second component 3 and 5 mix with each other in order to form the adhesion promoter. The adhesion promoter formed is then able to flow without hindrance out of the spout 15 and then out of the pourer 16 for an application of the adhesion promoter.

According to the exemplary embodiment of FIG. 6, the retaining means 28 are formed as fingers, as a rubber band and/or as a ring engaging around at least some sections of the periphery of the piercing means 25.

According to the exemplary embodiment of FIG. 7, as distinct from the exemplary embodiment according to FIG. 6, the retaining means 28 are formed as a substantially shell-like intermediate wall joined to the wall 6 or the sealing region 26 over its entire circumference, for example a diaphragm or a thin sheet, which automatically closes the spout 15 in a fluid-tight manner.

If the piercing means 25 experiences a predetermined acceleration 46, then this breaks through the intermediate wall 28, in particular formed as a thin sheet. The further process then corresponds to that as has been described for FIG. 6, that is to say the ball pierces the second chamber 4 and mixing of the first and second component 3 and 5 occurs. Pouring out the adhesion promoter formed through the broken retaining means 28 and pouring the same out for an application through the spout 15 and the pourer 16 is enabled.

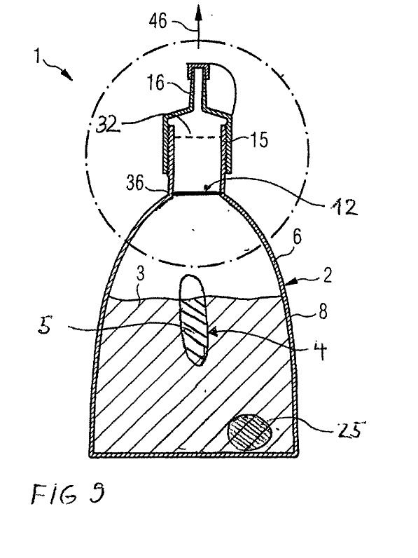

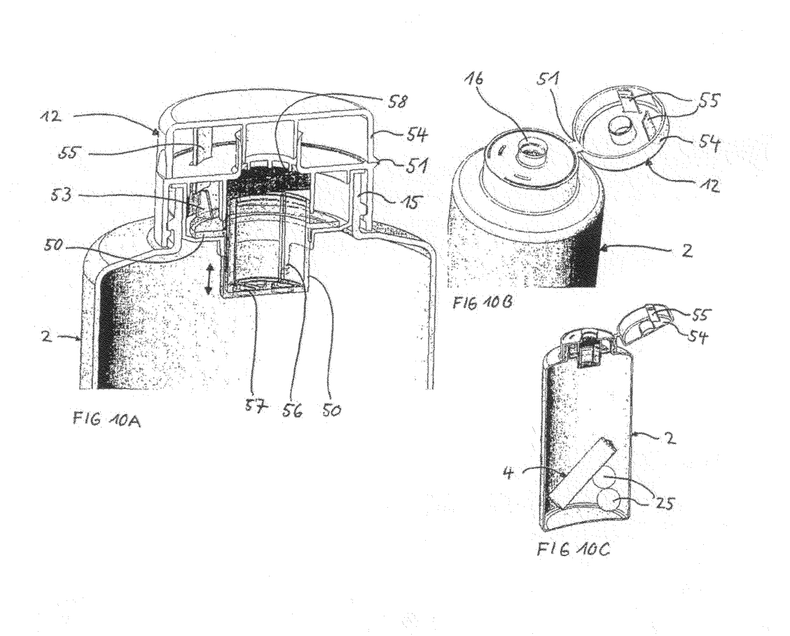

In the exemplary embodiment according to FIG. 8, as distinct from the exemplary embodiment according to FIG. 6, the piercing means 25 closes an opening 47 in the pourer 16 in the stored state of the multicomponent packaging 1. The retaining means 28 are formed as in the exemplary embodiment according to FIG. 6 or 7. In addition, here the retaining means or, respectively, the diaphragm can be destroyed by pressing the lid down. As a result of pressing the lid down, the piercing means 25 is forced down and forced through the diaphragm 28, so that the piercing means 25 and the spout are opened. The piercing means 25 then causes mixing of the first and second component 3 and 5 in accordance with the exemplary embodiment according to FIG. 6. A filter can be fitted in the spout in order to filter out the parts of the second chamber.

In the exemplary embodiment according to FIG. 9, as distinct from the exemplary embodiment according to FIG. 8, the piercing means 25 is arranged in the bottle in the first chamber. In addition to the second component 5, the second chamber 4 also has a proportion of gas, so that the second chamber 4 floats in the first component 3. The spout 15 is closed by a closure means 12 which, here, is configured as a diaphragm. However, this closure means can also be configured in another way; it is merely important that it is destroyed by the piercing means and the spout is thus opened. This diaphragm is arranged in the region 36. If the bottle is then shaken, the second chamber 4, which is preferably configured as a glass ampoule, is destroyed by the piercing means and the second component 5 is released. During further shaking, the two components are mixed and, given further intense shaking, the closure means 12 is destroyed.

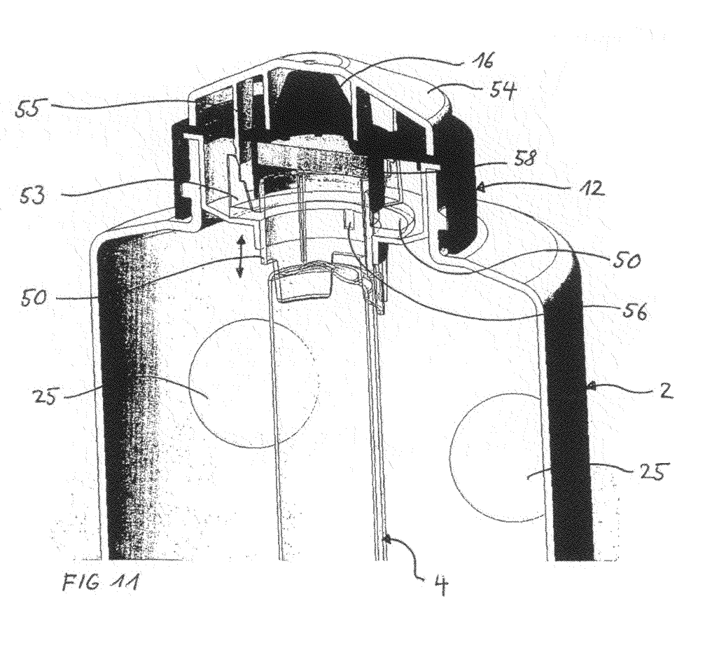

A further embodiment of the invention is illustrated in FIGS. 10A, 10B and 10C. Here, in a way analogous to FIG. 9, the second chamber 4 floats and the at least one piercing means 25 floats freely in the first chamber 2, FIG. 10C. The closure means 12 is implemented as a flap closure having a hinge 51 and is pressed onto the first chamber 2, that is to say the spout 15 of the first chamber 4. Before the closure means 12 is pressed on, an insert 52 having a holder 50 is inserted into the spout 15. The holder is designed such that it can move, so that a web 53 of the holder 50 is forced upward. This web presses on a snap fixing 55 arranged in the lid 54 of the closure means 12. In a closed state of the closure means, this snap fixing engages in the lower part of the closure means by means of an undercut, so that the lid 54 cannot be opened. If the holder 50 is then moved in the direction of the lid, the web 53 encounters the snap fixing 55 and forces the latter to the side, so that this snap fixing can no longer engage in the lower part of the closure means. In this way, the lid 54 is released and can be opened. The holder 50 can be kept in the opened position by means of a latching device 56, so that the lid 54 can be opened and closed as desired.

If the bottle is shaken, the second chamber 4, which is preferably configured as a glass ampoule, is destroyed by the piercing means 25 and the second component 5 is released. During further shaking, the two components are mixed and, given further intense shaking, the holder 50 is forced upward, the web 53 releases the snap fixing 55 and the lid 54 can be opened and the mixed components can be poured out.

In order to prevent the fragments of the second chamber 4 being poured out, a coarse mesh 57 can be arranged in the spout area, preferably in the holder. Furthermore, a filter 58 can be arranged before the pourer 16 in order to filter out extremely fine parts.

An exemplary embodiment analogous to FIG. 10 is illustrated in FIG. 11. However, here the second chamber 4 is held by the holder 50. Here, after the second chamber 4 has been destroyed by shaking the piercing means 25, the holder and, respectively, the web 53 and therefore the snap fixing 55, can be moved in order to release the lid 54. The lid 54 can then be taken off and the pourer can be opened by cutting off the tip of the pourer. However, in a manner analogous to FIG. 10, it is also possible to use a closure means 12 illustrated there with lid and hinge or, respectively in FIG. 11, the lid from FIG. 10.

The invention is not restricted to the specific structure of a multicomponent packaging illustrated in the above figures.

For instance, more than two chambers, for example three or four chambers, can also be provided, each containing different solid, liquid and/or gaseous components. In all the exemplary embodiments, the closure means can be fitted in such a way that it can no longer be removed, for example by means of welding, pressing on, and so on.

List of designations

| | |
|---|---|
| 1 | Multicomponent packaging |
| 2 | First chamber |
| 3 | First component |
| 4 | Second chamber |
| 5 | Second component |
| 6 | Wall |
| 7 | Space |
| 8 | Base body |
| 11 | Opening |
| 12 | Closure means |
| 13 | Space |
| 14 | Wall |
| 15 | Spout |
| 16 | Pourer |
| 17 | Screw connection |
| 21 | End |
| 22 | Closure |
| 23 | Opening |
| 24 | Securing strip |
| 25 | Piercing means |
| 26 | Sealing region |
| 27 | End |
| 28 | Retaining means |
| 31 | End |
| 32 | Filter |
| 34 | Spike |
| 35 | Rod |
| 36 | End |
| 37 | Base |
| 41 | End |
| 42 | Direction |
| 43 | Intended fracture point |
| 44 | Broken-off end |
| 45 | End |
| 46 | Acceleration |
| 47 | Opening |
| 48 | Opening |
| 50 | Holder |
| 51 | Hinge |
| 52 | Insert |
| 53 | Web |
| 54 | Lid |
| 55 | Snap fixing |
| 56 | Latching device |
| 57 | Coarse mesh |
| 58 | Filter |

1. A multicomponent packaging for packaging at least a first and a second component, the multicomponent packaging comprising:
a first chamber to hold a first component, the first chamber having an opening, for removal of a mixture of the first component and a second component;
a second chamber arranged within the first chamber to hold the second component; and
a closure means which, in a stored state of the multicomponent packaging, closes the opening in a fluid-tight manner.

2. The multicomponent packaging as claimed in claim 1, comprising;
a piercing means for piercing the second chamber by shaking the multicomponent packaging in a state of readiness for pouring out the mixture, the piercing means being arranged within one of the first chamber and the second chamber.

3. The multicomponent packaging as claimed in claim 1, wherein the closure means is formed by the second chamber.

4. The multicomponent packaging as claimed in claim 2, wherein the piercing means is permanently coupled to the closure means and, in relation to the second chamber, is arranged such that a piercing movement of the piercing means effects the piercing of the second chamber and actuates the closure means to open the opening.

5. The multicomponent packaging as claimed in claim 2, wherein the closure means is formed by the piercing means.

6. The multicomponent packaging as claimed in claim 2, comprising:
a retaining means arranged in an area of the opening and which retains the piercing means in the stored state and releases the piercing means as a function of an acceleration acting on the multicomponent packaging in the state of readiness.

7. The multicomponent packaging as claimed in claim 2, wherein the second chamber comprises:
a wall which is of a material such that a piercing movement of the piercing means with a predetermined kinetic energy leads to the piercing of the second chamber.

8. The multicomponent packaging as claimed in claim 1, wherein the first chamber is flexible, wherein the second chamber substantially forms the closure means, and wherein an end compression of the first chamber leads to a piercing second chamber.

9. The multicomponent packaging as claimed in claim 1, comprising:
a wall of the second chamber which is formed of at least one of glass, metal, and plastic.

10. The multicomponent packaging as claimed in claim 1, wherein the opening in the first chamber is formed as a pipe-shaped spout.

11. The multicomponent packaging as claimed in claim 10, wherein the spout is adjoined by a pourer that is pipe-shaped.

12. The multicomponent packaging as claimed in claim 1, wherein the piercing means includes at least one ball which has a more solid material than that of a wall of the second chamber and/or cutting means for boring through the wall of the second chamber.

13. The multicomponent packaging as claimed in claim 1, wherein the first and/or the second chamber is only partly filled.

14. The multicomponent packaging as claimed in claim 1, wherein the mixture of the first component and the second component is an adhesion promoter.

15. The multicomponent packaging as claimed in claim 14, wherein the first component has an activation agent, and/or the second component has a precursor compound.

16. A method for the removal of a mixture from a multicomponent packaging having at least one first chamber, which holds a first component, and a second chamber arranged within the first chamber, which holds a second component, the method comprising:
piercing the second chamber by a piercing means;
mixing the first and second components to form the mixture;
opening an opening in the first chamber closed by a closure means; and
pouring the mixture out of the opening.

17. The method as claimed in claim 16, comprising:
piercing the second chamber;
then mixing the first and second components to form the mixture; and
subsequently or together with the piercing of the second chamber, opening the opening in the first chamber.

18. The method as claimed in claim 16, comprising:
piercing, as the second chamber is pierced, firstly a wall of the second chamber facing the first chamber by the piercing means; and
subsequently, or substantially simultaneously, piercing a wall facing away from the first chamber, which forms the closure means and belongs to the second chamber, by the piercing means.

19. The method as claimed in claim 16, comprising:
moving, during the piercing or directly following the piercing of the second chamber, the closure means to open the opening, by a mechanical coupling to the piercing means.

20. The method as claimed in claim 16, comprising:
opening, firstly the opening in the first chamber by the piercing means, which forms the closure means, then piercing the second chamber by the piercing means; and
following this, mixing the first and second components to form an adhesion promoter.

21. The method of claim 16, wherein the mixture is an adhesion promoter.
